(19) United States
(12) Patent Application Publication
(10) Pub. No.: US 2007/0050132 A1
(43) Pub. Date: Mar. 1, 2007

(54) Route-inquiry Method which generates a plurality of feasible routes according to a source and a destination

(76) Inventors: Dai-Shui Ho, Taipei (TW); Xin Hu, Shanghai City (CN)

Correspondence Address: NORTH AMERICA INTELLECTUAL PROPERTY CORPORATION, P.O. BOX 506, MERRIFIELD, VA, 22116, US

(21) Appl. No.: 11/467,903

(22) Filed: Aug. 28, 2006

(30) Foreign Application Priority Data
Aug. 29, 2005 (TW) 094129553

(51) Int. Cl. G01C 21/00

(52) U.S. Cl. 701/209; 701/200

(57) ABSTRACT

After a user inputs a source, a destination and preferences, many different routes will be generated accordingly. Some of the routes may have shorter estimated traveling times, some of the routes may have shorter traveling distances, but other routes may make use of freeways. Different kinds of routes can be indicated simultaneously and thus the user can choose an optimal route perceived by the user from the generated routes.

### BACKGROUND OF THE INVENTION

1. Field of the Invention

The present invention relates to a route-inquiry method, and more particularly, to a route-inquiry method which generates a plurality of feasible routes according to a source and a destination.

2. Description of the Prior Art

Please refer to FIG. 1. FIG. 1 is a flowchart illustrating a prior art route-inquiry method 100. The method 100 is performed as follows:

Step 110: Start;

Step 120: Input a source and a destination;

Step 130: Generating a route according to the source and the destination;

Step 140: Display the route;

Step 150: End.

Generally, the route generated in step 130 is considered with the traveling distance, that is, if a user wants to travel to the destination from the source, the method 100 will generate a route with the shortest distance. However, if the user wishes to find a route with other preferences such as the shortest time, the method 100 is unable to find a corresponding route to satisfy the user's request.

### SUMMARY OF THE INVENTION

The present invention provides a route-inquiry method comprising generating a plurality of feasible routes according to a source and a destination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a prior art route-inquiry method.

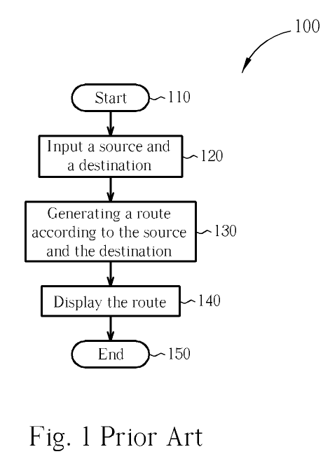

FIG. 2 is a flowchart illustrating a route-inquiry method according to the present invention.

FIG. 3 is a diagram illustrating indication of a plurality of routes in a map mode.

FIG. 4 is a diagram illustrating indication of the plurality of routes in FIG. 3 in a pathway mode.

FIG. 5 is a diagram illustrating indication of the plurality of routes in FIG. 3 in a parameter mode.

FIG. 6 is a block diagram illustrating a route-inquiry device according to the present invention.

### DETAILED DESCRIPTION

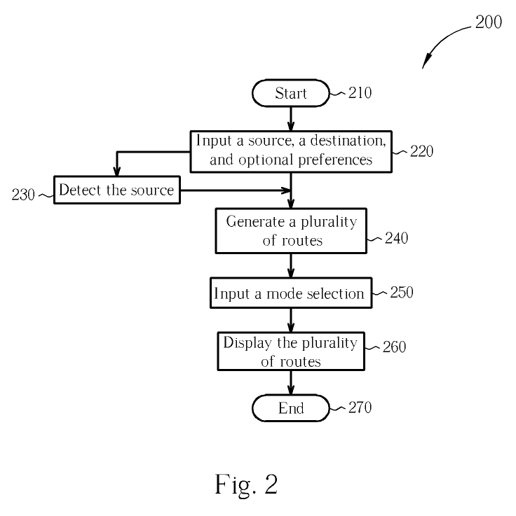

Please refer to FIG. 2. FIG. 2 is a flowchart illustrating a route-inquiry method 200 according to the present invention. The method 200 comprises the following steps:

Step 210: Start;

Step 220: Input a source, a destination, and optional preferences, then go to step 240; if only a destination is input, then go to the step 230;

Step 230: Detect the source;

Step 240: Generate a plurality of routes according to the source, the destination, and optional preferences;

Step 250: Input a mode selection;

Step 260: Display the plurality of routes according to the mode selection;

Step 270: End.

In step 220, a user does not have to enter the source. Instead, the route-inquiry method 200 provides the step 230 to detect the source. If the user does not enter the source, the step 230 detects the position of the user and uses the position of the user as the source. The position of the user can be detected by a Global Positioning System (GPS).

In step 240, a plurality of routes are generated, which provides the user many traveling choices. The optional preferences can include estimated traveling time, preferred roads, road condition, etc. For example, if the optional preference of shorter estimated traveling time is selected, then step 240 will generate a plurality of routes with shorter estimated traveling times. If the optional preference of preferred roads is selected, the step 240 will generate a plurality of routes each of which includes the preferred roads. If the optional preference of road condition is selected, the step 240 will generate a plurality of routes which avoid roads with traffic jam and roads under construction, etc. Further, the method 200 allows the user to select more than one optional preference. For example, the user can select the optional preferences of shorter estimated traveling time and preferred roads at the same time. In that case, step 240 will generate a plurality of routes with shorter estimated traveling times and include the preferred roads. Further if no optional preferences are selected, then step 240 will generate a plurality of routes with a predetermined preference.

In step 250, the user can choose to select a display mode. The display mode can be a map mode, a pathway mode, a parameter mode, etc. Then in step 260, the plurality of routes are displayed according to the selected mode. If the map mode is selected, the plurality of routes generated in step 240 will be highlighted on a map with different routes highlighted in different manners such as different colors, line shapes, etc. If the pathway mode is selected, the names of pathways along each of the routes generated in step 240 will be displayed in sequence to indicate the route. If the parameter mode is selected, certain parameters such as time, distance, etc. of the plurality of routes generated in step 240 will be displayed. The combination of different modes allows the user to choose an optimal route more appropriately. If none of the modes are selected, then the plurality of routes will be displayed according to a predetermined mode.

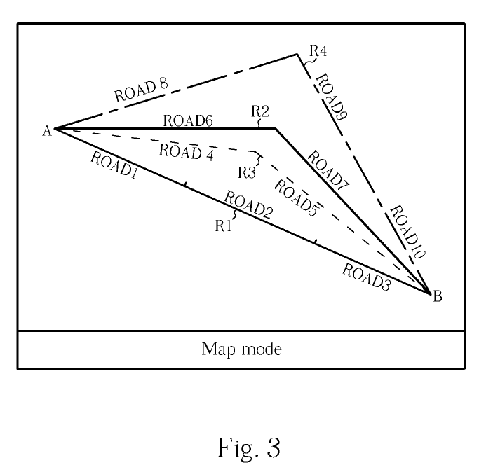

Please refer to FIG. 3. FIG. 3 is a diagram illustrating indication of a plurality of routes R1-R4 generated in step 240 in the map mode. As shown in FIG. 3, the source is A, the destination is B, and routes R1-R4 are displayed in the map with different symbolic lines. Moreover, the symbolic lines can be assigned with different meanings. For example, a dashed line as shown in route R2 can be used to indicate that it is the route with the shortest estimated traveling time. In this case, the map mode provides the user information not only routes R1-R4 on the map, but information regarding to estimated traveling time. Furthermore, when the user makes a request to display only the route which is chosen, all other routes will disappear from the map.

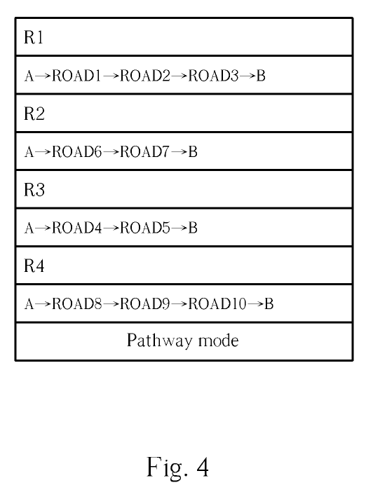

Please refer to FIG. 4. FIG. 4 is a diagram illustrating indication of routes R1-R4 in the pathway mode. As shown in FIG. 4, routes R1-R4 are displayed by names of pathways along each of routes R1-R4. For instance, route R1 starts at road 1, passes through road 2, and finishes at road 3. The display of routes R1-R4 can be sorted by different preferences. For example, if the preference of distance is selected, then route R1 will remain on the top list, followed by route R3, R2, and R4 referencing to FIG. 3.

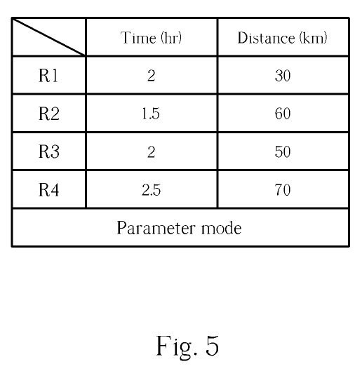

Please refer to FIG. 5. FIG. 5 is a diagram illustrating indication of routes R1-R4 in the parameter mode. As shown in FIG. 5, certain parameters such as estimated traveling time and distance of routes R1-R4 are displayed. For example, route R2 has the estimated traveling time of 1.5 hours, and the distance of 60 kilometers. If the user wants to select a route with more freeways, the user may choose route R4 although it has a longer distance than some other routes.

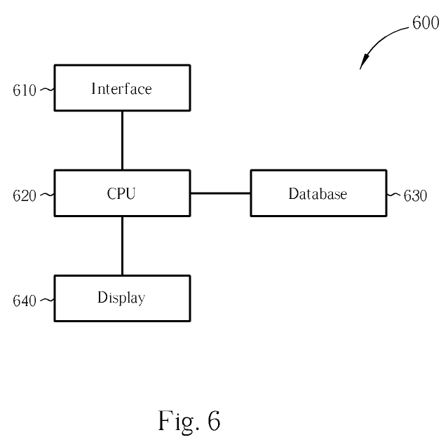

Please refer to FIG. 6. FIG. 6 is a block diagram illustrating a route-inquiry device 600 of the present invention. As shown in FIG. 6, the route-inquiry device 600 includes an interface 610, a central processing unit(CPU) 620, a database 630, and a display 640. The interface 610 is for the user to input information such as the source, the destination and preferences. The database 630 is disposed for storing data such as different pathways. The central processing unit 620 is used to search and generate different routes for the user according to input data. The display 640 is used to display different routes generated by the central processing unit 620.

The route-inquiry device and method of the present invention provide the user many different kinds of information regarding different routes. Therefore, the user is able to choose an optimal route perceived by the user from a plurality of routes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A route-inquiry method comprising:
generating a plurality of feasible routes according to a source and a destination; and
indicating the plurality of feasible routes simultaneously.

2. The method of claim 1 further comprising selecting a route from the plurality of feasible routes.

3. The method of claim 1 further comprising inputting the destination.

4. The method of claim 3 further comprising inputting the source.

5. The method of claim 3 further comprising detecting the source through a Global Positioning System (GPS).

6. The method of claim 1 wherein generating the plurality of feasible routes according to the source and the destination comprises generating one of the plurality of feasible routes according to the source, the destination and accessible pathways.

7. The method of claim 1 further comprising estimating a traveling time from the source to the destination for each of the feasible routes.

8. The method of claim 7 further comprising comparing estimated traveling times of the feasible routes.

9. The method of claim 1 further comprising setting priorities for the plurality of feasible routes.

10. The method of claim 9 wherein generating the plurality of feasible routes according to the source and the destination comprises generating the plurality of feasible routes according to the source, the destination and the priorities of the plurality of feasible routes.

11. The method of claim 1 further comprising calculating distances of the feasible routes.

12. The method of claim 11 further comprising comparing the distances of the feasible routes.

13. The method of claim 1 wherein indicating the plurality of feasible routes comprises indicating names of pathways along each of the feasible routes.

14. The method of claim 13 wherein indicating the names of pathways along each of the feasible routes comprises displaying the names of pathways along each of the feasible routes.

15. The method of claim 13 wherein indicating the names of pathways along each of the feasible routes comprises indicating the names of pathways along each of the feasible routes through a speaker.
